(19) United States
(12) Patent Application Publication
(10) Pub. No.: US 2013/0194242 A1
(43) Pub. Date: Aug. 1, 2013

(54) MULTI-TIP STYLUS PEN FOR TOUCH SCREEN DEVICES

(71) Applicant: PINEAPPLE ELECTRONICS, INC., Los Angeles, CA (US)

(72) Inventors: Jason Jae Woo Park, Los Angeles, CA (US); Jay Hyong Woo, La Mirada, CA (US); Paul Minsok Yun, Fullerton, CA (US)

(73) Assignee: PINEAPPLE ELECTRONICS, INC., Los Angeles, CA (US)

(21) Appl. No.: 13/751,542

(22) Filed: Jan. 28, 2013

Related U.S. Application Data
(60) Provisional application No. 61/591,391, filed on Jan. 27, 2012.

(51) Int. Cl. G06F 3/0354

(52) U.S. Cl. CPC G06F 3/03545
USPC 345/179

(57) ABSTRACT

In a multi-tip stylus pen for a touch-screen device includes an elongated body member which may be capped with a hollow cap member. The hollow cap member has a first stylus tip member disposed at one of the cap ends without an opening. The first stylus tip member includes a first rounded tip of a material and shape suitable for contact with the touch-screen. The elongated body member has a second stylus tip member disposed at a first end. The second stylus tip member comprises a second stylus tip having a second rounded tip of a material and shape suitable for contact with the touch-screen. A third stylus tip member may be disposed at a second end of the body member. The third stylus tip comprises a third rounded tip of a material and shape suitable for contact with the touch-screen.

### CROSS REFERENCE TO RELATED APPLICATIONS

This application claims priority to U.S. Provisional Patent Application No. 61/591,391, filed Jan. 27, 2012, the disclosure of which is hereby incorporated by reference in its entirety.

### FIELD

Embodiments relate to input devices for touchscreen device, more specifically to multi-tip stylus pen for electronic devices with touchscreens.

### BACKGROUND

Touch-screens are both an output interface for displaying information from an electronic device to the user and an input interface for inputting information by the user into electronic devices. Touch-screens are often intended to be used with fingers. While fingers may provide adequate touch resolution for inputting some types of information, they may be inadequate for other types of information. For example, fingers may provide inadequate touch resolution when the user wishes to input information requiring a higher degree of touch resolution such as in intricate drawing or a signature. For such types of input information a stylus pen having the requisite degree of touch resolution may provide a solution. However, a stylus pen having adequate touch resolution for one type of input information may not have adequate resolution for another type of input information. For example, a stylus pen having a relatively high degree of resolution for inputting hand writing may have too high of a resolution for creating artistic brush strokes. In addition, a stylus pen having a relatively low touch resolution adequate for typing on large on-screen keyboard of a relatively large touch-screen device such as a tablet computer may be inadequate for typing on small on-screen keyboard of a relatively small touch-screen device such as mobile phone. Under these circumstances, carrying multiple stylus pens having multiple touch resolutions may be cumbersome. Thus, there is a need for a stylus pen having more than one stylus tip with multiple touch resolutions.

### SUMMARY OF THE INVENTION

In one embodiment, a multi-tip stylus pen includes an elongated body member having a first end and a second end and a hollow cap member. The hollow cap member comprises an inner cavity with an opening at a first end configured to receive the second end of the body member. A first stylus tip member is disposed at a second end of the hollow cap member. The first stylus tip member comprising a first stylus tip is disposed at the second end of the hollow cap member. The first stylus tip comprises a first rounded tip of a material and shape suitable for contact with the touchscreen. The embodiment further comprises a second stylus tip member disposed at the first end of the body member. The second stylus tip member comprises a second stylus tip comprising a second rounded tip of a material and shape suitable for contact with the touch-screen. Additionally, a third stylus tip member is disposed at a second end of the body member and comprises a third stylus tip. The third stylus tip comprises a third rounded tip of a material and shape suitable for contact with the touchscreen.

In another embodiment, a multi-tip stylus pen includes an elongated body member having a first end and a second end and a hollow cap member. The hollow cap member comprises an inner cavity with an opening at a first end configured to receive the second end of the body member. A first stylus tip member is disposed at a second end of the hollow cap member. The first stylus tip member comprising a first stylus tip is disposed at the second end of the hollow cap member. The first stylus tip comprises a first rounded tip of a material and shape suitable for contact with the touchscreen. The embodiment further comprises a second stylus tip member disposed at the first end of the body member. The second stylus tip member comprises a second stylus tip comprising a second rounded tip of a material and shape suitable for contact with the touchscreen.

### BRIEF DESCRIPTION OF THE DRAWINGS

FIG. 1 is a schematic view illustrating an input to the touch screen device made in the form of a hand-drawn picture made using a multi-tip stylus pen, according to an embodiment of the present invention.

FIG. 2 is an elevational side view illustrating a multi-tip stylus pen with a cap member covering a portion of the body member according to an embodiment of the present invention, showing first and second stylus tip members.

FIG. 3 is an elevational side view illustrating the multi-tip stylus pen of FIG. 2 with the cap member disengaged from the body member, showing first, second, and third stylus tip members.

FIG. 4A is a close up view of an end of the cap member of FIG. 2, showing a first tip member according to an embodiment of the present invention.

FIG. 4B is an end view of the cap member of FIG. 4B.

FIG. 5A is a close up view of an end of the body member of FIG. 2, showing a second tip member according to an embodiment of the present invention.

FIG. 5B is an end view of the body member of FIG. 5A.

FIG. 6 is a side elevational view of a multi-tip stylus pen according to another embodiment, showing a cap removed and a writing tip at one end of the body member.

### DETAILED DESCRIPTION OF PREFERRED EMBODIMENTS

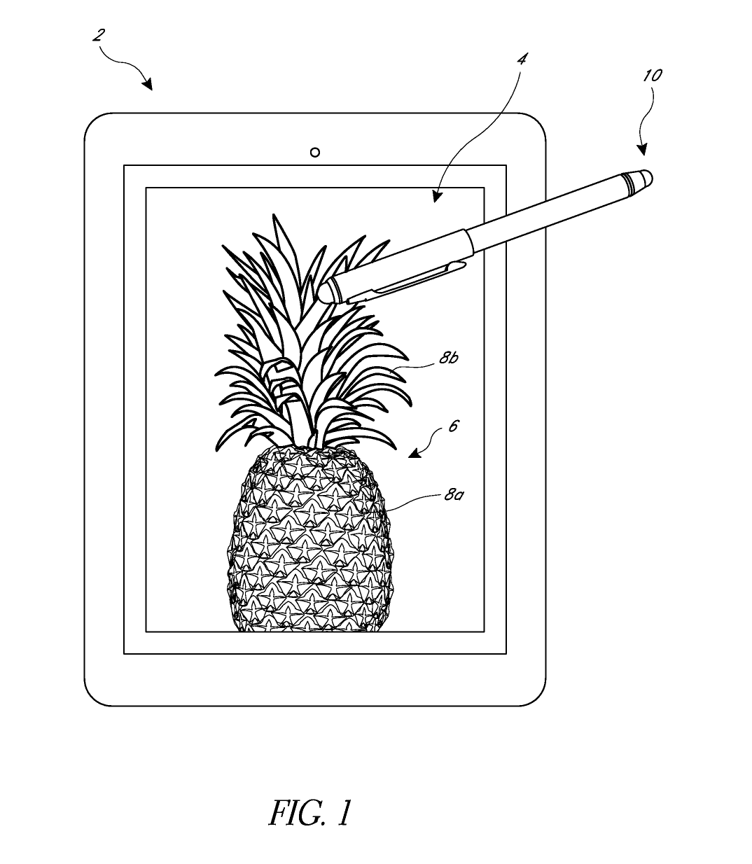

Referring to FIG. 1, a multi-tip stylus pen 10 is illustrated alongside with a touch-screen device 2. The touch screen device 2 includes a touch screen 4. Depicted in FIG. 1 is an input drawing 6 made using the multi-tip stylus pen 10.

While the touch-screen device 2 illustrated in FIG. 1 is a tablet computer, electronic devices that may be used with a multi-tip stylus pen 10 include any touch screen-enabled electronic devices including game consoles, desktop computers, laptop computers, mobile phones, smartphones, personal digital assistants (PDAs), satellite navigation devices, cameras, GPS units, interactive displays in automobiles or on appliances, and similar devices.

A touchscreen 4 is a component of an electronic device that functions both as a visual display output device as well as an input device that allows a user to input information into the electronic device. The touchscreen enables the user to interact directly with what is displayed, rather than using a mouse, touchpad, or any other intermediate “pointer” device (other than a stylus, which is optional for most modern touchscreens). A user may input information in the form of a simple touch or multi-touch gestures. The simple touch or multi-touch gestures may be generated by human fingers or by a suitable touch input device such as a stylus pen or other similar means that are able to generate electrical signals in the electronic device in response to the touch.

Under certain circumstances, the user may prefer a human finger or a relatively coarse touch input device, such as a stylus tip pen having a stylus tip with a tip size similar in dimensions to a human finger. This may be the case for typing on a relatively large key board displayed on the touchscreen of a relatively large device such as a tablet computer. Similarly, making broad-stroked lines 8b such as that may be present in the drawing 6 may be best performed with a human finger or a stylus pen having a relatively large stylus tip. The touchscreen device may also recognize the use of a larger stylus and react to it differently, e.g., treat a large stylus as an eraser in a drawing program, which smaller stylus tips are treated as pens. Under other circumstance, the user may prefer a touch input device such as a stylus pen having a stylus tip size substantially smaller than a human finger. Such may be the case when typing on a relatively small key board displayed on the touchscreen of a relatively small device, such as a smartphone. Such may also be the case when a user wishes to hand sign an electronic document. Similarly, making fine lines 8a such as that may be present in the drawing 6 may be best performed using a stylus pen having a relatively small stylus tip. It is relatively common for people to carry multiple touch screen devices having varying sizes of touch screens that may be best utilized with multiple stylus tips. Carrying multiple stylus tip pens having different tip sizes may be cumbersome. Thus, there is a need for a stylus pen having multiple stylus tips for multiple purposes.

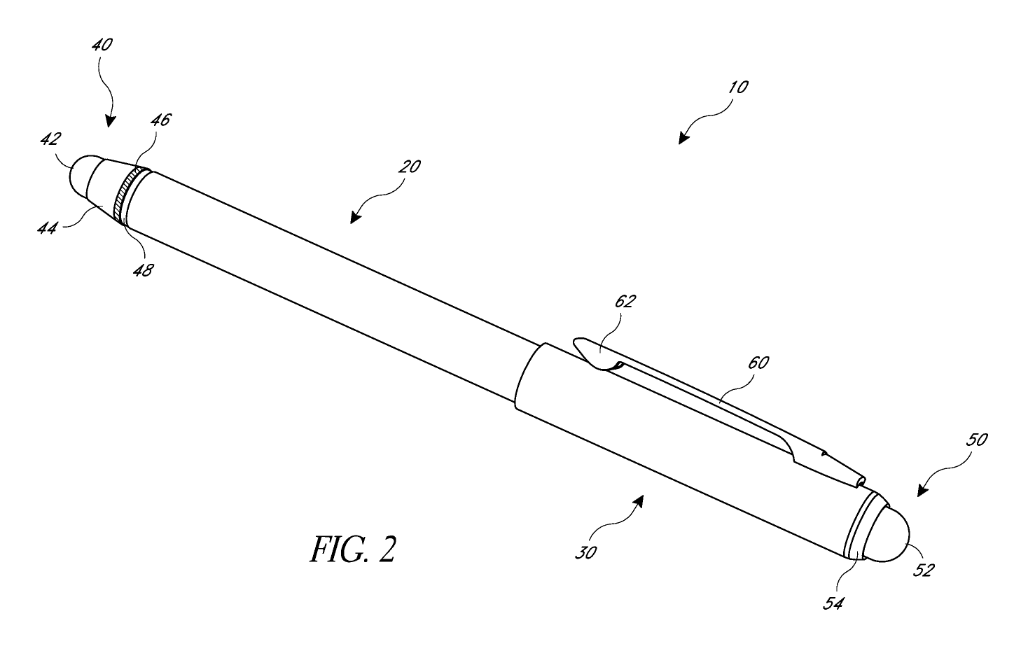

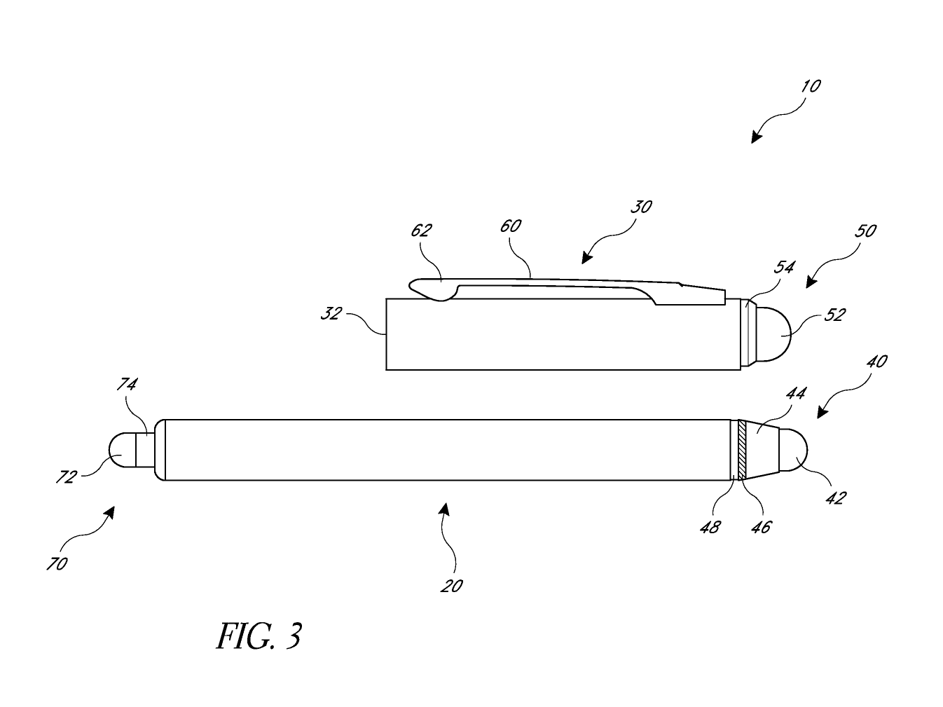

In FIGS. 2 and 3, a multi-tip stylus pen 10 according to a preferred embodiment of the invention is illustrated. In particular, a multi-tip stylus pen 10 includes an elongated body member 20 having a first end and a second end and a hollow cap member 30. The hollow cap member 30 comprises an inner cavity with an opening 32 at a first end configured to receive the second end of the body member 20, and optional also to receive the first end of the body member 20. A first stylus tip member 50 comprising a first stylus tip 52 is disposed at a second end of the hollow cap member 30. The first stylus tip 52 comprises a first rounded tip of a material and shape suitable for contact with the touchscreen. The preferred embodiment further comprises a second stylus tip member 40 disposed at the first end of the body member 20. The second stylus tip member 40 comprises a second stylus tip 42 comprising a second rounded tip of a material and shape suitable for contact with the touchscreen. Additionally, a third stylus tip member 70 is disposed at a second end of the body member 20 and comprises a third stylus tip 72. The third stylus tip 72 comprises a third rounded tip of a material and shape suitable for contact with the touchscreen.

FIG. 2 illustrates the multi-tip stylus pen 10 in which the hollow cap member 30 has received the body member 20 such that the hollow cap member 30 covers a substantial portion of the body member 20. FIG. 3 illustrates the multi-tip stylus pen 10 in which the body member 20 and the hollow cap member 30 are disengaged from each other and shows the entire length of the body member 20.

In FIG. 2, the hollow cap member 30 has received the second body end of the elongated body member 20 such that the portion of the body member 20 inside the hollow cap member 30 is not shown. In an embodiment, the portion of the length of the body member 20 that is enclosed inside the hollow cap member 30 when fully inserted is approximately 20-40% of the length of the body member 20. In another embodiment, the portion is approximately 40-60%. In yet another embodiment, the portion is approximately 60-80%.

While FIG. 2 shows the hollow cap member 30 having received the second end of the elongated body member 20, other embodiments are possible. In another embodiment, the cap member 30 may receive the first end of the elongated body member 20. As noted, the hollow cap member 30 can be configured to fit over both the first end and the second end of the body member 20.

Additionally, an O-ring 46 may be included between at either end the first or the second end of the elongated body member 20. When present, the O-ring may improve the fit between the outer surface of first or the second end of the elongated body member 20 and the inner surface of the hollow cap member 30 to have a more secure fit between them. The O-ring 46 may be supported by an O-ring gasket 48.

The hollow cap member 30 comprises hollow cavity walls that surround the body member 20 when the hollow cap member 30 has received the body member 20. In one embodiment, the hollow cavity walls have a thickness ranging from 0.1 to 0.5 mm. In another embodiment, the hollow cavity walls have a thickness ranging from 0.5 to 1 mm. In yet another embodiment, the hollow cavity walls have a thickness ranging from 1 to 2 mm.

The first stylus tip 52 comprises a first rounded tip of a shape suitable for making contact with the touch screen 4. In the illustrated embodiment in FIG. 2, the first rounded tip 52 comprises a first hemispherical dome tip portion and a first cylindrical portion. The first hemispherical dome tip portion and the first cylindrical portion have substantially the same diameters such that the first hemispherical dome tip portion makes a smooth transition into the first cylindrical portion with a continuously varying radius of curvature.

FIG. 2 illustrates the second stylus tip member 40 disposed at the first end of the body member 20. The second stylus tip 42 comprises a first rounded tip of a shape suitable for making contact with the touch screen. In the illustrated embodiment in FIG. 2, similar to the first rounded tip 52, the second rounded tip 42 comprises a second hemispherical dome tip portion and a second cylindrical portion that have substantially the same diameters such that the second hemispherical dome tip portion makes a smooth transition into the second cylindrical portion with a continuously varying radius of curvature.

Referring to FIG. 3, the disengaged elongated body member 20 includes the third stylus tip member 70 disposed at the second end. The third stylus tip 72 comprises a third rounded tip of a shape suitable for making contact with the touch screen. In the illustrated embodiment in FIG. 3, similar to the first and second rounded tips 52 and 42, the third rounded tip 72 comprises a third hemispherical dome tip portion and a third cylindrical portion that have substantially the same diameters such that the third hemispherical dome tip portion makes a smooth transition into the third cylindrical portion with a continuously varying radius curvature.

While the first, second, and third rounded tips of first, second, and third stylus tips 52, 42, and 72 in FIGS. 2 and 3 are illustrated with circular-symmetric shapes including a hemispherical dome tip portion and a cylindrical portion, other shapes are possible in other embodiments. Any one of the first, second, and third rounded tips of the first, second, and third stylus tips 52, 42, and 72 may be formed of other suitable shapes such that the first stylus tips have cross-sectional views in a direction perpendicular to the lengthwise direction that are not circular symmetric. For example, any one of the first, second, and third rounded tips may be shaped such that at least one cross-sectional area is in the shape of an oval triangle, rectangle, a pentagon, a hexagon, an octagon, a diamond, or any other suitable shape.

One of the considerations in designing the rounded tips to enhance the user experience is the elasticity of the tips. The elastic constant of a tip relates to the amount of force perpendicular to the plane of the touch screen 4 that may be applied to achieve a desirable input to the touch screen. For example, in making a drawing such as the drawing 6 in FIG. 1, a tip having a relatively high elastic constant entails a correspondingly higher amount of vertical force to generate the same area of contact between the stylus tip and the touch screen compared to a tip having a relatively low elastic constant. In some embodiments, the rounded tips are designed to have a correspondence between the amount of vertical force and the resulting lines that resemble, for example, an actual correspondence that a user expects from physical artistic tools such as brushes and pastels. In other embodiments, the elastic constant of the rounded tips may be optimized to provide maximum protection to the touch screen. The elasticity depends on many factors, including the elasticity of the tip material, the shape of the tip, whether the tips are solid or hollow, and whether there are other elasticity enhancing features embedded within the tips (e.g., a spring).

A related consideration in designing the rounded tips is the friction coefficient between the tip surface and the touch screen surface. The friction coefficient relates to the amount force parallel to the plane of the touch screen 4 that may be applied to achieve a desirable input to the touch screen. In some embodiments, the rounded tips are designed to have lowest friction coefficient practically achievable to render a freely gliding feel to the user. In other embodiments, the rounded tips are designed to have a higher friction coefficient. Again referring the example of the drawing 6 in FIG. 1, the rounded tips may be designed to have a correspondence between the amount of lateral force and the resulting lines that resemble, for example, an actual correspondence that a user expects from physical artistic tools such as brushes and pastels to enhance the user experience. The friction coefficient depends on many factors, including the material type of the tip and the shape of the tip.

As the amount of lateral force that may be applied to generate an input on a touch screen also depends on the area of contact between the stylus tip and the touch screen, an optimum user experience may be obtained when the elastic coefficient and the friction coefficient are optimized as a whole.

In this connection, in an embodiment of the present invention, any one of first, second, and third rounded tips of the first, second, and third stylus tips 52, 42, and 72 in FIGS. 2 and 3 may have a hollow cavity formed therein and a cavity wall thickness. In an embodiment, the cavity wall may have a thickness ranging from 0.1 to 2 mm. In another embodiment, the cavity wall may have a thickness ranging from 0.3 to 0.8 mm. In yet another embodiment, the cavity wall may have a thickness ranging from 0.4 to 0.7 mm. Other embodiments are possible where any one of first, second, and third rounded tips of the first, second, and third stylus tips 52, 42, and 72 have their entire volume filled with a filler material. In an embodiment, the filler material may be the same material as the stylus tip material. In another embodiment, the filler material may be a different material from the stylus tip material. Other embodiments are possible where any one of first, second, and third rounded tips of the first, second, and third stylus tips 52, 42, and 72 has a spring member inside hollow cavity to optimize the elasticity of the tips.

In an embodiment, the tip material comprises a conductive rubber-based material. In another embodiment, the tip material comprises a conductive silicone-based material. In yet another embodiment, the tip material comprises a conductive polymeric fiber-based material.

In some embodiments the conductivity of any one of first, second, and third stylus tips 52, 42, and 72 may be improved by having a conductive coating thereon to render a conductive surface. The conductive coating may comprise a Ni or Cu coating. In an embodiment, the conductive coating may comprise a Ni coating having a thickness in the range of about 0.5 to 2 microns. In another embodiment, the conductive coating may comprise a Cu coating having a thickness in the range of 5 to 10 microns.

In one embodiment, the resistivity of any one of first, second, and third stylus tips 52, 42, and 72 may be between 0.01 and 0.1 Ohms. In another embodiment, the resistivity may be between 0.1 to 1 Ohms. In yet another embodiment, the resistivity may be between 1 to 5 Ohms.

Reliability against repeated use is another design consideration. In this connection, in an embodiment, any one of first, second, and third stylus tips 52, 42, and 72 may be designed to withstand 10,000 cycles of lateral strokes 3 cm in length traversed in 2 seconds in a direction parallel to a touch screen surface while applying a vertical force of 1.0 N in a direction perpendicular to the touch surface. In another embodiment, the stylus tip may be designed to withstand 15,000 cycles of lateral strokes 3 cm in length traversed in 2 seconds in a direction parallel to a touch screen surface while applying a vertical force of 1.0 N in a direction perpendicular to the touch surface.

Another aspect of a user experience is the availability of various tip sizes and their positions within the multi-tip stylus pen 10. For example, a user may find it convenient to have two most-frequently used tip sizes disposed at the first body end of the body member 20 and the second cap end of the hollow cap member 30 such that they are readily available without having to disengage the hollow cap member 30 from the body member 20. In addition, a user may find it beneficial to have the most fragile tip among the multiple tips be disposed at the second body end of the body member 20 so that it benefits from the protection of the hollow cap member 30.

In this connection, in one embodiment of the present invention, the first rounded tip of the first stylus tip 52 has a first base width greater than a second base width of the second rounded tip of the second stylus tip 42. In another embodiment, the second rounded tip of the second stylus tip 42 has a second base width greater than a third base width of the third rounded tip of the third stylus tip 72. Various other embodiments are possible wherein the second base width is greater than the first base width, third base width is greater than the first base width, or the third base width is greater than the second base width.

Referring to FIG. 3, the body member 20 comprises an elongated grip portion disposed between the second and third stylus tip members 40 and 70. In an embodiment, the grip portion of the body member 20 includes an elongated cylindrical tube. The grip member may further include a hollow cavity extending in the lengthwise direction of the cylindrical tube. In an embodiment where grip member includes a hollow cavity, the cylindrical tube may have a tube wall having a thickness ranging from 0.1 to 0.5 mm. In another embodiment, the cylindrical tube may have a tube wall having a thickness ranging from 0.5 to 1 mm. In yet another embodiment, the cylindrical tube may have a tube wall having a thickness ranging from 1 to 2 mm.

While the stylus pen 10 of FIG. 3 shows a body member being a cylindrical shape, other embodiments are possible. For example, the geometric shape of the body member may be chosen such that it has at least one cross sectional area having a shape chosen from the group consisting of a circle, an oval, a triangle, rectangle, a pentagon, a hexagon, an octagon, and a diamond. A non-circular symmetric shape may prevent the multi-tip stylus pen 10 from inadvertently rolling off a sloped surface, for example a desk.

The grip portion of the body member 20 may comprise any suitable material having the weight, stiffness, and other mechanical properties to enhance the user experience both aesthetically and functionally. A suitable material for the grip portion of the body member may include a metal such as brass, stainless steel, aluminum, and titanium. A suitable material may also include non-metals such as glass, gem, plastic, ceramic, graphite-reinforced composite materials, and wood-derived materials.

One of the considerations in designing the body member 20 is improving the surface finish to minimize slipping in user's hand, especially in the presence of moisture. In this connection, in an embodiment of the present invention, the surface of the body member may include an anti-slip surface produced at least in part by sanding. In another embodiment, the surface may include an anodized surface. In these embodiments, the degree of sanding and anodization is chosen to achieve a degree of surface roughness in the grip portion of the body member 20 suitable for gripping without slipping in user's hand.

In the foregoing description of embodiments in connection with FIGS. 2 and 3, first and second ends of the body member 20 and the second end of the hollow cap member 30 comprise stylus tip members. Other embodiments are possible. For example, any one of the first and second ends of the body member 20 and the second end of the hollow cap member may comprise a writing member or a light source member.

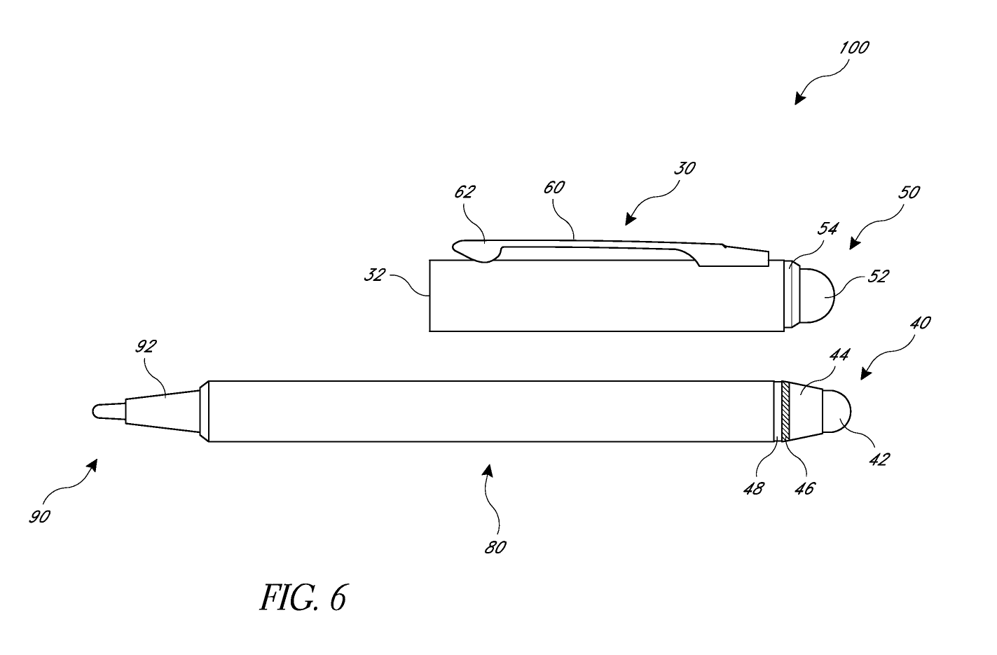

In particular, in the embodiment illustrated in FIG. 6, a multi-tip stylus pen 100 includes an elongated body member 80 having a first end and a second end and a hollow cap member 30. The hollow cap member comprises an inner cavity with an opening 32 at a first end configured to receive the second end of the body member 20. A first stylus tip member 50 comprising a first stylus tip 52 is disposed at the second end of the hollow cap member 30. The first stylus tip 52 comprises a first rounded tip of a material and shape suitable for contact with the touchscreen. The embodiment further comprises a second stylus tip member 40 disposed at the first end of the body member 80. The second stylus tip member 40 comprises a second stylus tip 42 comprising a second rounded tip of a material and shape suitable for contact with the touchscreen.

In the illustrated embodiment in FIG. 6, instead of the third stylus member 70 of FIGS. 2 and 3, the multi-tip stylus pen 100 comprises a writing member 90 disposed at a second end of the body member 80. The writing member comprises a writing tip 92 suitable for writing on a writing surface. A suitable writing tip 92 includes a ball point tip, a felt tip, a pencil tip, a marker tip, and the like.

In the embodiment in FIG. 3, the first, second, and third stylus tip members 50, 40, and 70 further comprises first, second, and third link members 54, 44, and 74 that couple the first stylus tip 52 with the hollow cavity member 30 at the second cap end, the second stylus tip 42 with the body member 20 at its first body end, and the third stylus tip 72 with the body member 20 at its second end. Any one of the first, second and third link members 54, 44, and 74 may be a double-sided male connection with a middle stopper. For example, the first link member 54 may have a first male connection inserted into the first stylus tip 52 and a second male connection be inserted into the second end of the hollow cap member 30. The second link member 44 may have a first male connection inserted into the second stylus tip 42 and a second male connection be inserted into the second end of the body member 20. Similarly, the third link member 74 may have a first male connection inserted into the third stylus tip 72 and a second male connection be inserted into the first end of the body member 20. In each of first, second, and third link members, the middle stopper prevents one of the male connections from being over-inserted. In addition, each of the first, second, and third link members may comprise an electrically conductive material.

While the first, second, and third link members 54, 44, and 74 are described as double-sided male connectors, in other embodiments the link members may have either or both of the male connectors replaced with a female connector configured to receive a male connector from any one of the first, second, and third tip members or any one of the first end of the body member 20, the second end of the body member 20, and the second cap end of the hollow cap member 30.

In an embodiment, any one of the first, second, and third link members 54, 44, and 74 may be a removable link member configured such that when one or more of the first, second, and third stylus tips 52, 42, and 72 become worn out, any one of them may be replaced with a replacement stylus tip by disengaging the stylus tips from the corresponding removable link.

The first, second, and third link members 54, 44, and 74 may comprise a metallic material such as brass, stainless steel, aluminum, and titanium. In an embodiment, the metallic material may be a C3604-type brass. In another embodiment, the first, second and third link members 54, 44, and 74 may be chrome-plated.

In the illustrated embodiment of FIGS. 2 and 3, the hollow cap member 30 includes an elastic clip 60 designed to attach the hollow cap member 30 of the multi-tip stylus pen 10 to any sufficiently thin sheets, such as the cover of the touch screen device 2. The elastic clip 60 is also designed to attach to clothing, such as a shirt pocket. The elastic clip 60 is immovably attached to the hollow cap member 30 at a first end and has a clip head portion 62 at a second end. An elongated lever portion extends from a point of attachment to the hollow cap member 30 along the axis of the length of the hollow cap member 60 and terminates at a second end at the clip head portion 62. The elastic clip 60 works though a lever action such that when the clip head portion 62 is pulled in a direction perpendicular to the surface of the hollow cap member 30 at a position of overlap between the surface the hollow cap member 30 and the clip head portion 62, the lever action creates a spring force tending to pull the head portion 62 back towards the surface of the hollow cap member 30. The elasticity of the elongated lever portion is designed such that the hollow cap member 30 and the multi-tip stylus pen 10 may be attached to a sheet or a shirt pocket without making a permanent mark thereon. In an embodiment, the elastic clip 60 is designed to withstand a pulling force of 5.5 lbf to 8.7 lbf measured at the clip head portion with the force applied for a time exceeding 10 seconds in a direction perpendicular to the surface of the hollow cap member 30 at the point of overlap between the surface of the hollow cap member 30 and the clip head portion 62. In another embodiment, the elastic clip 60 is designed to withstand a force of 8.7 lbf to 9.6 lbf. In yet another embodiment, the elastic clip 60 is designed to withstand a force of 9.6 to 20.1 lbf. When a multi-tip stylus pen having a cylindrical body member 20 and a cylindrical hollow cap member 30 is placed on a sloped surface, the elastic clip 60 also prevents the stylus pen 10 from rolling down the slope to prevent loss or breakage.

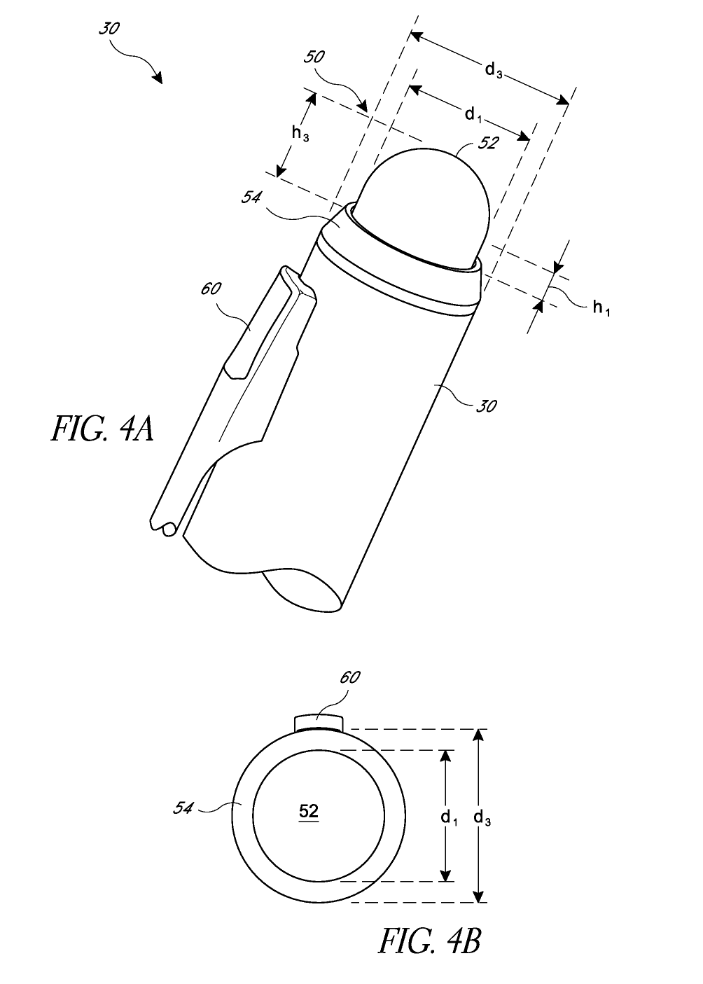

FIG. 4A illustrates an enlarged view of the first stylus tip member 50 disposed at the second cap end the hollow cap member 30. FIG. 4B is an end view of the enlarged tip member 50 of FIG. 4A, viewed from the second cap end of the cap member 30 in a direction parallel to an axis of elongation of the cap member 30 towards the first cap end of the cap member 30. The views in FIGS. 4A and 4B are enlarged views of the cap member 30 of FIGS. 2 and 3, annotated with various dimensions according to an aspect of the present invention. The first stylus tip 52 has a first base width d₁ and a first vertical height h₃. In particular, the first stylus tip 52 in FIGS. 4A and 4B comprises a first hemispherical dome tip portion and a first cylindrical portion. Therefore, the first vertical height h₃ includes the first cylindrical portion height h₁, and the first base width d₁ corresponds to the common diameter of the first hemispherical dome tip portion and the first cylindrical portion.

In the illustrated embodiment, the first base width d₁ of the first stylus tip 52 is narrower than the cap width d₃ of the cap member 30. In other embodiments, the first base width d₁ may be equal or wider than the cap width d₃ of the cap member 30.

In an embodiment, the first stylus tip 52 may have a first base width d₁ between 6.5 mm and 9 mm. In another embodiment, the first stylus tip 52 may have a first base width d₁ between 6.5 and 7.5 mm. In yet another embodiment, the first stylus tip 52 may have a first base width d₁ between 6.7 and 7.3 mm, or about 7.0 mm.

In an embodiment, the first height h₃ is between 3 and 5 mm. In another embodiment, the first vertical height h₃ is between 5 and 7 mm. In yet another embodiment, the first vertical height h₃ is between 7 and 9 mm.

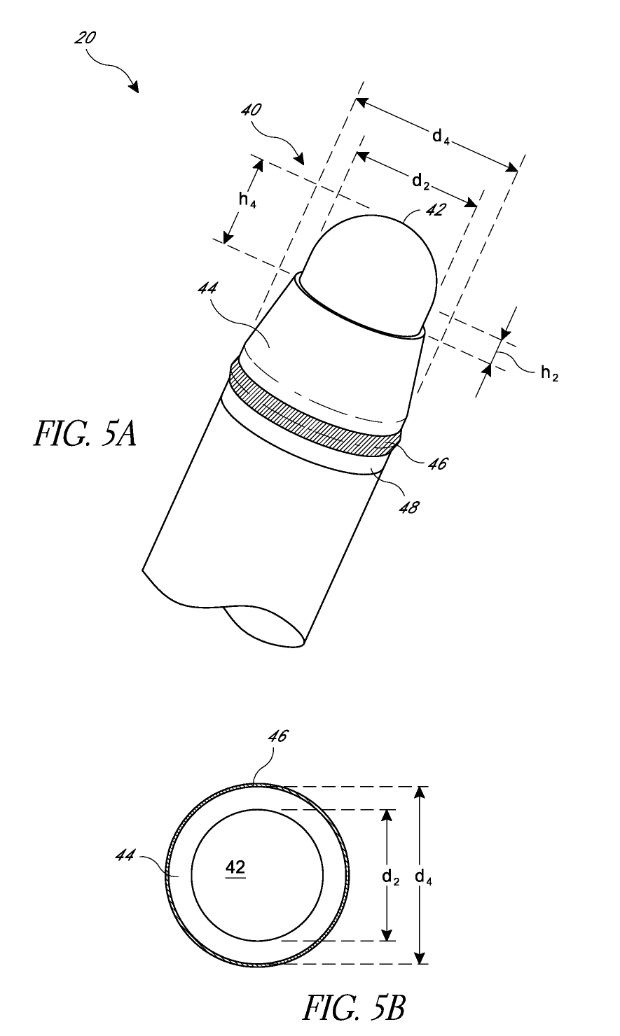

FIG. 5A illustrates an enlarged view of the second stylus tip member 40 disposed at the first body end of the body member 20. FIG. 5B is an end view of the enlarged first tip member 40 of FIG. 4A, viewed from the first body end of the cap member 30 in a direction parallel to an axis of elongation of the body member 20 towards the second end of the body member 20. The views in FIGS. 5A and 5B are enlarged views of the body member 20 of FIGS. 2 and 3 annotated with various dimensions according to an aspect of the present invention. The second stylus tip 42 has a second base width d₂ and a second vertical height h₄. In particular, the second stylus tip 42 in FIGS. 4A and 4B comprises a second hemispherical dome tip portion and a second cylindrical portion. Therefore, the second vertical height h₄ includes the second cylindrical portion height h₂ and the second base width d₂ corresponds to the common diameter of the second hemispherical dome tip portion and the second cylindrical portion.

In the illustrated embodiment, the second base width d₂ of the second stylus tip 42 is narrower than a body width d₄ of the body member 20. In other embodiments, the second base width d₂ may be equal or wider than the body width d₄ of the body member 20.

In an embodiment, the second stylus tip 42 may have a second base width d₂ between 5.5 mm and 6.5 mm. In another embodiment, the second stylus tip 42 may have a second base width d₂ between 5.7 and 6.3 mm. In yet another embodiment, the second stylus tip 42 may have a second base width d₂ between 5.9 and 6.1 mm, or about 6.0 mm.

In an embodiment, the second height h₃ is between 3 and 5 mm. In another embodiment, the second height h₃ is between 5 and 7 mm. In yet another embodiment, the second height h₃ is between 7 and 9 mm.

While not illustrated the third stylus tip 72 may be configured similar to the first and second stylus tips 52 and 42. In particular, in an embodiment, the third stylus tip 72 may have a third base width d₅ and a third vertical height h₆. In particular, the third stylus tip 72 may comprise a third hemispherical dome tip portion and a third cylindrical portion. Therefore, the third vertical height h₆ includes a third cylindrical portion height h₅ and the third base width d₅ corresponding to the common diameter of the third hemispherical dome tip portion and the third cylindrical portion.

In an embodiment, the third base width d₅ of the third stylus tip 72 may be narrower than a body width d₄ of the body member 20. In other embodiments, the third base width d₅ may be equal or wider than the body width d₄ of the body member 20.

In an embodiment, the third stylus tip 72 may have a third base width d₅ between 1.0 mm and 5.5 mm. In another embodiment, the third stylus tip 42 may have a third base width d₅ between 3 mm and 5.3 mm. In yet another embodiment, the third stylus tip 72 may have a third base width d₃ between 4.8 and 5.2 mm, or about 5.0 mm.

In an embodiment, the third height h₆ is between 3 and 5 mm. In another embodiment, the third height h₆ is between 5 and 7 mm. In yet another embodiment, the third height h₆ is between 7 and 9 mm.

Although this invention has been described in terms of certain embodiments, other embodiments that are apparent to those of ordinary skill in the art, including embodiments that do not provide all of the features and advantages set forth herein, are also within the scope of this invention. Moreover, the various embodiments described above can be combined to provide further embodiments. In addition, certain features shown in the context of one embodiment can be incorporated into other embodiments as well. Accordingly, the scope of the present invention is defined only by reference to the appended claims.

What is claimed is:

1. A multi-tip stylus pen for inputting information into a computing device through touching a touchscreen of the computing device comprising:
an elongated body member having a first end and a second end;
a hollow cap member comprising:
an inner cavity with an opening at a first end of the cap member configured to receive the second end of the body member; and
a first stylus tip member disposed at a second end of the cap member, the first stylus tip member comprising a first stylus tip, the first stylus tip comprising a first rounded tip of a material and a shape suitable for contact with the touchscreen;
a second stylus tip member disposed at the first end of the body member, the second stylus tip member comprising a second stylus tip, the second stylus tip comprising a second rounded tip of a material and shape suitable for contact with the touchscreen; and
a third stylus tip member disposed at a second end of the body member, the third stylus tip member comprising a third stylus tip, the third stylus tip comprising a third rounded tip of a material and shape suitable for contact with the touchscreen.

2. The stylus pen of claim 1, wherein the first rounded tip has a first base width greater than a second base width of the second rounded tip.

3. The stylus pen of claim 2, wherein the first rounded tip comprises a first hemispherical dome tip portion, the first dome tip portion having a first diameter substantially equal to the first base width, and a first cylindrical portion, the first cylindrical portion having the first diameter.

4. The stylus pen of claim 2, wherein the second rounded tip has a second base width greater than a third base width of the third rounded tip.

5. The stylus pen of claim 4, wherein the second rounded tip comprises a second hemispherical dome tip portion, the second dome tip portion having a second diameter substantially equal to the second base width, and a second cylindrical portion, the second cylindrical portion having the second diameter.

6. The stylus pen of claim 4, wherein the body member comprises an elongated cylindrical portion having a body diameter greater than the first base width.

7. The stylus pen of claim 4, wherein the hollow cap member is configured to receive the first end of the body member.

8. The stylus pen of claim 1, wherein any one of the first, second, and third stylus tips are coupled to the body member through an electrically conductive removable link member.

9. The stylus pen of claim 1, wherein the first stylus tip has a first diameter between 6.5 mm and 9 mm.

10. The stylus pen of claim 9, wherein the second stylus tip has a second diameter between 5.5 mm and 6.5 mm.

11. The stylus pen of claim 10, wherein the third stylus has a third diameter between 1.0 mm and 5.5 mm.

12. The stylus pen of claim 1, wherein at least one of the first stylus tip, the second stylus tip, or the third stylus tip comprises a hollow cavity enclosed therein and a cavity wall having a cavity wall thickness.

13. The stylus pen of claim 12, wherein the at least one of the first, second, and third stylus tips comprise an elastomeric material, the elastomeric material designed to deform in a direction parallel to an axis of elongation of the body member towards the touch screen by an amount proportional to an amount of force applied in the elongate direction.

14. The stylus pen of claim 13, wherein the elastomeric material comprises a silicone-based material.

15. The stylus pen of claim 13, wherein the elastomeric material comprises a rubber-based material.

16. The stylus pen of claim 13, wherein the cavity wall thickness is between 0.3 mm and 0.8 mm.

17. The stylus pen of claim 16, wherein the at least one of the first, second, and third stylus tips have a resistivity between 0.01 and 1 Ohms.

18. The stylus pen of claim 1, wherein any one of the first, second, and third rounded tips have at least one cross section having a shape chosen from a group consisting of a circle, an oval, a triangle, rectangle, a pentagon, a hexagon, an octagon, and a diamond.

19. The stylus pen of claim 1, wherein the body member has at least one cross section area having a shape chosen from a group consisting of a circle, an oval, a triangle, rectangle, a pentagon, a hexagon, an octagon, and a diamond.

20. The stylus pen of claim 1, wherein the cap member has a length sufficient to cover at least one third of the body member.

21. The stylus pen of claim 1, wherein the cap member further comprises an elastic clip configured to attach the cap member to a sheet or a shirt pocket.

22. A multi-tip stylus pen for inputting information into a computing device through touching a touchscreen of the computing device comprising:
an elongated body member having a first end and a second end;
a hollow cap member comprising:
an inner cavity with an opening at a first end of the cap member configured to receive the second end of the body member; and
a first stylus tip member disposed at a second end of the cap member, the first stylus tip member comprising a first stylus tip, the first stylus tip comprising a first rounded tip of a material and shape suitable for contact with the touchscreen;
a second stylus tip member disposed at the first end of the body member, the second stylus tip member comprising a second stylus tip, the second stylus tip comprising a second rounded tip of a material and shape suitable for contact with the touchscreen; and

23. The stylus pen of claim 22, further comprising a writing member disposed at a second end of the body member, the writing member comprising writing tip suitable for writing on a writing surface.

24. The stylus pen of claim 23, wherein the writing tip is a ball point tip.
